(19) United States
(12) Patent Application Publication
(10) Pub. No.: US 2017/0116711 A1
(43) Pub. Date: Apr. 27, 2017

(54) IMAGE RECONSTRUCTION METHOD AND DEVICE, GLASSES DEVICE AND DISPLAY SYSTEM

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Wei Wang, Beijing (CN); Hao Zhang, Beijing (CN); Xue Dong, Beijing (CN)

(21) Appl. No.: 15/239,263

(22) Filed: Aug. 17, 2016

(30) Foreign Application Priority Data
Oct. 27, 2015 (CN) 201510708689.8

(51) Int. Cl. G06T 3/40; G02B 27/01; H04N 5/232; H04N 5/372; G06K 9/58

(52) U.S. Cl. CPC G06T 3/4069; H04N 5/372; G06K 9/58; H04N 5/23232; G02B 27/0172; G06T 2200/28; G02B 2027/0178; G02B 2027/014

(57) ABSTRACT

An image reconstruction method and device, a glasses device and a display system. The image reconstruction device includes: an image collecting unit, a processing unit and an image combination unit. The image collecting unit is configured to collect an initial image that has pixel gaps between adjacent pixel groups; the processing unit is configured to reconstruct the initial image to form a reconstructed image, where a position of each pixel group in the reconstructed image corresponds to a pixel gap adjacent to a corresponding pixel group in the initial image; and the image combination unit is configured to combine the initial image and the reconstructed image to generate an output.

### TECHNICAL FIELD

Embodiments of the present disclosure relate to an image reconstruction method and device, a glasses device and a display system.

### BACKGROUND

With update and development of technologies in the display field, products having high resolution are gradually predominant in the display field, and with improvement of life quality, products having high resolution are more and more popular. Currently, a main development direction of a display apparatus is to reduce pixel sizes and increase the number of pixels to achieve high resolution display.

However, for a medium-size or small-size product, the higher the resolution is, the more the number of pixels is on an unit area, and the smaller the size of a pixel is, resulting in more difficulty in a manufacturing process of the display apparatus. Therefore, a yield rate of the products is reduced and the cost is significantly increased. For a large-size product, a high resolution means a greater number of pixel dots, which causes a higher requirement on driving ability of a single sub-pixel and a higher manufacturing cost of the product.

Therefore, in the case that the high resolution display is achieved by continuously reducing the size of the pixels and increasing the number of the pixels, the difficulty in the research and development of the products is continuously increased, and generally, a huge amount of investment is needed in this type of research and development. Furthermore, due to the limit restriction on the physical size, the size of the pixels cannot be indefinitely reduced in the manufacturing process of the pixels to improve the resolution for displaying images. In the current manufacturing condition, the resolution of the display device cannot be further improved using existing manners in simple ways.

### SUMMARY

Embodiments of the present disclosure provide an image reconstruction device. The image reconstruction device includes: an image collecting unit, a processing unit and an image combination unit. The image collecting unit is configured to collect an initial image that has pixel gaps between adjacent pixel groups; the processing unit is configured to reconstruct the initial image to form a reconstructed image, where a position of each pixel group in the reconstructed image corresponds to a pixel gap adjacent to a corresponding pixel group in the initial image; and the image combination unit is configured to combine the initial image and the reconstructed image to generate an output.

Embodiments of the present disclosure provide a glasses device including the image reconstruction device.

Embodiments of the present disclosure provide a display system including a display device and the image reconstruction device, where the display device is preset with gaps between adjacent pixel groups and is configured for displaying the initial image.

Embodiments of the present disclosure provide an image reconstruction method, including:

collecting an initial image that have pixel gaps between adjacent pixel groups;

reconstructing the initial image to form a reconstructed image, where a position of each pixel group in the reconstructed image corresponds to a pixel gap adjacent to a corresponding pixel group in the initial image; and

combining the initial image and the reconstructed image to generate an output.

### BRIEF DESCRIPTION OF THE DRAWINGS

In order to illustrate the technical solutions in the embodiments of the present disclosure or the existing arts more clearly, the drawings need to be used in the description of the embodiments or the existing arts will be briefly described in the following; it is obvious that the drawings described below are only related to some embodiments of the present disclosure, for one ordinary skilled person in the art, other drawings can be obtained according to these drawings without making other inventive work.

FIG. 1 is a block diagram showing a structure of an image reconstruction device according to an embodiment of the present disclosure;

FIG. 2A is a schematic diagram showing a pixel reconstruction process according to an embodiment of the present disclosure;

FIG. 2B is a schematic diagram showing a pixel reconstruction process according to another embodiment of the present disclosure;

FIG. 3 is a schematic diagram showing image combination performed by an image combination unit according to an embodiment of the present disclosure;

FIG. 4 is a schematic diagram showing projection preformed by using a projector according to an embodiment of the present disclosure;

FIG. 5 is a schematic diagram showing an image reconstruction process performed by using an image reconstruction device according to an embodiment of the present disclosure;

FIG. 6 is a schematic diagram showing a structure of a glasses device according to an embodiment of the present disclosure;

FIG. 7 is a block diagram showing a structure of a display system according to an embodiment of the present disclosure;

FIG. 8 is a flowchart diagram showing an image reconstruction method according to an embodiment of the present disclosure.

### DETAILED DESCRIPTION

Hereafter, the technical solutions of the embodiments of the present disclosure will be described in a clearly and fully understandable way in connection with the drawings related to the embodiments of the disclosure. It is obvious that the described embodiments are just a part but not all of the embodiments of the present disclosure. Based on embodiments of the present disclosure, all other embodiments obtained by those skilled in the art without making other inventive work should be within the scope of the present disclosure.

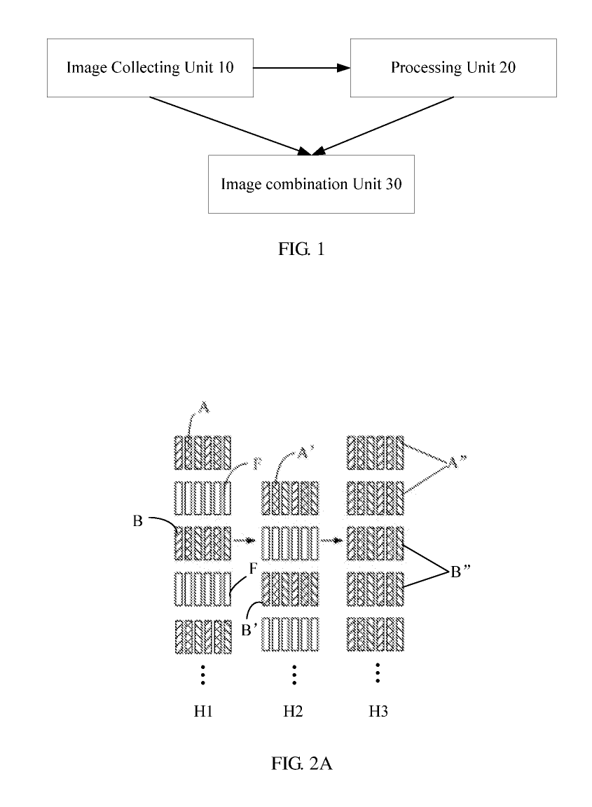

FIG. 1 is a schematic diagram showing a structure of an image reconstruction device according to an embodiment of the present disclosure.

With reference to FIG. 1, the image reconstruction device includes an image collecting unit 10, a processing unit 20 and an image combination unit 30.

For example, the image collecting unit 10 is used to collect an initial image, and there is a pixel gap between adjacent pixel groups in the initial image.

The processing unit 20 acquires the initial image from the image collecting unit 10, and reconstructs the initial image to form a reconstructed image. Each pixel group in the reconstructed image is located at a position that corresponds to a pixel gap adjacent to a corresponding pixel group in the initial image.

The image combination unit 30 acquires the initial image and the reconstructed image from the image collecting unit 10 and the processing unit 20 respectively, and generates an output after the initial image and the reconstructed image are combined.

In the above embodiment, by reconstructing the collected initial image, a position of a pixel group in the reconstructed image corresponds to a position of a pixel gap adjacent to the corresponding pixel group in the initial image. All pixels in the initial image and the reconstructed image can be displayed by combining the images to generate a combined image, so that the combined image can be displayed with high resolution, and an objective of displaying high resolution images with a display device having low resolution can be achieved.

In one embodiment, in order to achieve the above image reconstruction process, the image collecting unit 10 can employ a charge coupled device (CCD) sensor.

The CCD is generally made from semiconductor material having high photosensitivity, and includes multiple photosensitive units. Each photosensitive element is used to capture one pixel in an image, and each of the photosensitive units in the CCD is generally in the order of million pixels. The CCD can convert light into charges, and performs lattice sampling on pixels of a plane image; that is, when a surface of the CCD is irradiated by light, charges will be reflected on an assembly by each of the photosensitive units, and the charge signals generated by all the photosensitive units are arranged according to their corresponding positions, so that a complete image is formed. After the CCD camera captures the image, the image can be converted into a digital signal by an analog to digital conversion chip, and the digital signal can be stored in a storage device (such as a flash storage device) after being compressed. But the image collecting unit according to the embodiment of the present disclosure is not limited to being implemented by using a CCD, other image collecting devices having the same or similar functions can also be applied, and no limitation is placed in the present disclosure.

The CCD camera acquires image data, and after processing the image data, the CCD camera transmits the image data to the processing unit. For example, the processing unit 20 can be a computing device (e.g., a computer) having an image processing function, and the computing device can utilize its image processing function to change positions of pixels in an initial image so as to generate a reconstructed image.

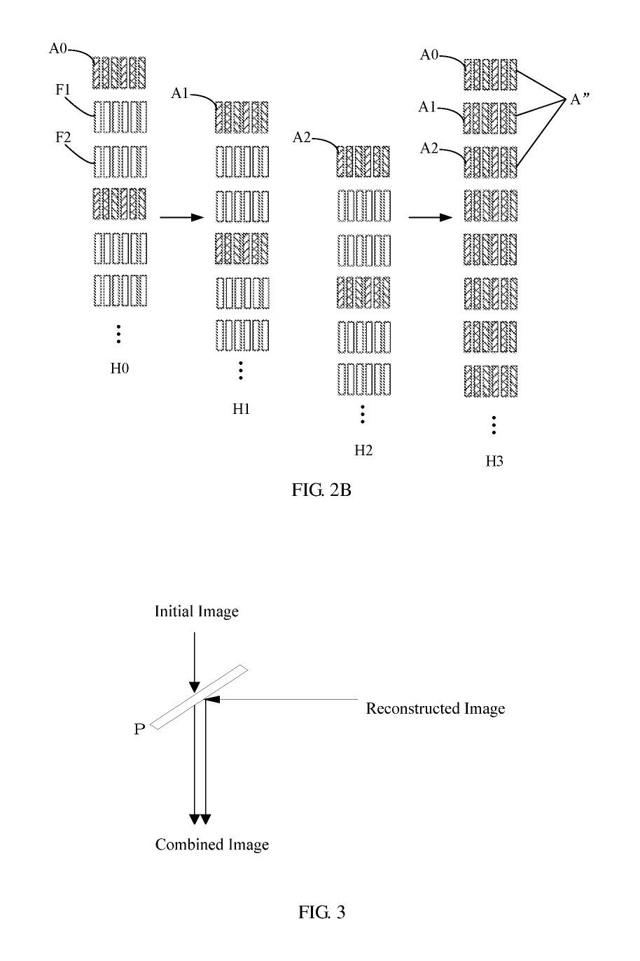

In the present embodiment, after the CCD acquires the initial image, the processing unit 20 can adjust positions of pixel groups in the acquired initial image. For example, after the CCD acquires the initial image, the processing unit 20 shifts all the pixel groups in the initial image received from the CCD according to an arrangement direction of pixel gaps pre-configured in the initial image, so that pixel groups in a reconstructed image are located at positions of respective pixel gaps that are respectively adjacent to the corresponding pixel groups in the initial image. FIG. 2A and FIG. 2B show two examples of the image reconstruction, which will be described below.

In addition, in the embodiments of the present disclosure, each pixel group in the initial image may be a pixel group taking one row of pixels as a unit, or may also be a pixel group taking one column of pixels as a unit. For example, each pixel group in the initial image may be a group of pixels in one row or a group of pixels in one column. Of course, it is appreciated that each of the pixel groups in the embodiments of the present disclosure is not limited thereto. For example, a pixel group can also take a single pixel as a unit. In addition, in the embodiments of the present disclosure, the image reconstruction is to shift the pixel groups in the initial image to the positions corresponding to the pixel gaps, and so, each of the pixel groups in the initial image has the same size as that of the corresponding pixel group in the reconstructed image. In order to achieve a combination of the initial image with the reconstructed image, each pixel gap between adjacent pixel groups may have a size larger than or equal to the size of one pixel group. If the size of the pixel gap is less than the size of one pixel group, due to the pixel gap being too small, an overlapped portion will be presented between corresponding pixel groups in the initial image and the reconstructed image when the images are combined. Thus, display of the combined image is affected. In addition, when the size of the pixel gap in the initial image is larger than the size of one pixel group, a position of a reconstructed pixel group located in a pixel gap is adjacent to the corresponding pixel group in the initial image, so as to avoid that a gap is formed between the two pixel groups in the combined image and to avoid influence on display of the image.

In some embodiments, since the size of each pixel group in the reconstructed image is equal to the size of the corresponding pixel group in the initial image, position complementation of pixel groups in the reconstructed image and pixel groups the initial image can be achieved when the size of one pixel gap is larger than or equal to the size of one pixel group in the reconstructed image. Thus, after the initial image is combined with the reconstructed image, an image with a double resolution can be formed when compared with the initial image.

For example, if the pixel groups in the initial image take a row of pixels as a unit, then the pixel groups in the reconstructed image are located at positions above or below the corresponding pixel groups in the initial image, and positions of the pixel groups in the reconstructed image correspond to the positions of the pixel gaps reserved in the initial image. Thus, the pixel groups in the initial image and the corresponding pixel groups in the reconstructed image are located at complementary positions, and thus, the image formed by combining the initial image and the reconstructed image can have an increased resolution.

In an embodiment as shown in FIG. 2A, pixel groups in the initial image take one row of pixels as a unit, and pixel groups in the reconstructed image also take one row of pixels as a unit. In the initial image H1, there is a pixel gap F between each two adjacent pixel groups, and the pixel gap F has a size larger than or equal to a size of one pixel group. The pixel groups in the reconstructed image H2 are located at positions complementary with positions of the corresponding pixel groups in the initial image H1. For example, a pixel group A′ of the reconstructed image is located at the pixel gap F below a corresponding pixel group A in the initial image (e.g., the pixel group A′ in the reconstructed image and the pixel group A in the initial image are corresponding to each other, and the pixel group A′ in the reconstructed image is obtained by shifting the pixel group A in the initial image to a location of the pixel gap F in the initial image). Similarly, another pixel group B′ in the reconstructed image is located at a pixel gap F below a corresponding pixel group B in the initial image, and so on and so forth; thus, the reconstructed image H2 can be formed. When the initial image H1 is combined with the reconstructed image H2, the pixel group A is combined with the pixel group A′ to form a new pixel group A″, the pixel group B is combined with the pixel group B′ to form a new pixel group B″, and so on and so forth; thus, the number of pixels in the combined image H3 is a double of that in the initial image. That is, the resolution of the combined image H3 is a double of that in the initial image.

In some other embodiments, as shown in FIG. 2B, the pixel groups in the initial image take one row of pixels as a unit, and the pixel groups in the reconstructed image also take one row of pixels as a unit. The size of each pixel gap is configured to be a double of the size of one pixel group, and in this case, the size of the pixel gap corresponds to the size of two identical pixel groups combined together. For example, the pixel gap F may include a first sub-gap F1 and a second sub-gap F2, and the first sub-gap F1 and the second sub-gap F2 each have a size corresponding to the size of one pixel group, respectively. In this case, two reconstructed images H1 and H2 can be used to combine with the initial image H0; that is, a position of a pixel group in a first reconstructed image H1 corresponds to a position of a first sub-gap F1 of a pixel gap below a corresponding pixel group in the initial image H0, and a position of a pixel group in a second reconstructed image H2 corresponds to a position of a second sub-gap F2 of the pixel gap below the corresponding pixel group in the initial image H0. Thus, after the initial image HO is combined with the two reconstructed images H1 and H2, the pixel groups of the first reconstructed image H1 are not overlapped with those of the second reconstructed image H2. The pixel groups of the first reconstructed image H1 are located at positions of the first sub-gaps F1 of the pixel gaps, the pixel groups of the second reconstructed image H2 are located at positions of the second sub-gaps F2 of the pixel gaps, and so, the pixel data of the combined image is a triple of that in the initial image, resulting in a triple resolution compared to that in the initial image. For example, a pixel group A1 of the first reconstructed image H1 is located at the first sub-gap F1 below a corresponding pixel group A0 of the initial image H0, a pixel group A2 of the second reconstructed image H2 is located at the second sub-gap F2 below the corresponding pixel group A0 of the initial image H0, and so on and so forth; thus, the first reconstructed image H1 and the second reconstructed image H2 are formed respectively. When the initial image H0, the first reconstructed image H1 and the second reconstructed image H2 are combined to form a combined image H3, the pixel groups A0, A1 and A2 are combined to form a new pixel group A″ in the combined image H3.

Base on the above discussion, in the embodiments of the present disclosure, the size of the pixel gap is not specifically confined, and at the same time, multiple reconstructed images can be combined with the initial image according to the size of the pixel gap. Thus, the resolution of the combined image can be improved multiply.

In yet another embodiment, the image combination unit may include a lens combination, and the lens combination is used to combine the pixel groups in the initial image with the pixel groups in the reconstructed image.

For example, as shown in FIG. 3, a half-reflecting and half-transmitting mirror P is provided in the lens combination. The half-reflecting and half-transmitting mirror P allows the initial image to transmit through and reflects the reconstructed image. Since the positions of the pixel groups in the two images (e.g., the initial image and the reconstructed image) are complementary, the pixel resolution of the combined image is higher than the two images. On the other hand, by making the half-reflecting and half-transmitting mirror P to reflect the initial image and to allow the reconstructed image to transmit through, the purpose of combining the two images can also be achieved, and no limitation is placed here.

In addition, in order to achieve the combination of the two images, in a specific embodiment the reconstructed image can be incident on the half-reflecting and half-transmitting mirror P in a projection manner. A projection device used in the embodiment can be any existing projector, for example, a LCD projector or a DLP projector.

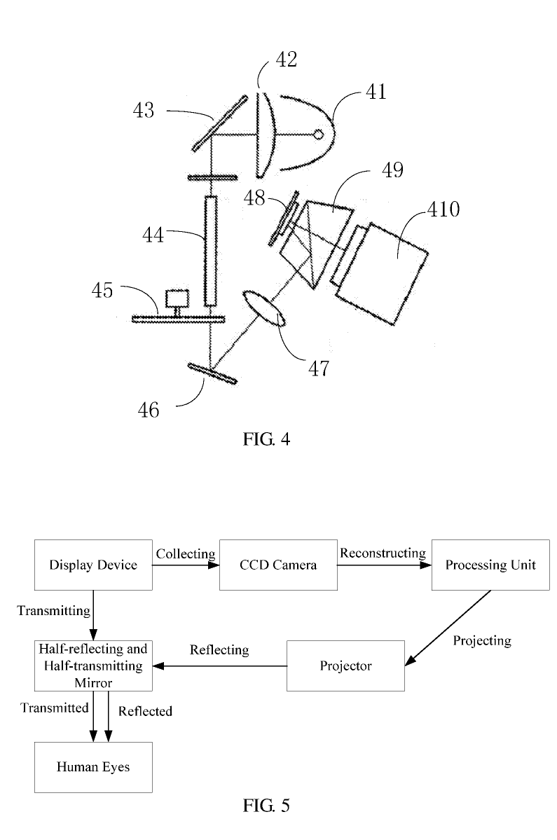

In an embodiment, for example, a single chip DLP projector is used. As shown in FIG. 4, an operation process of projecting the reconstructed image onto the half-reflecting and half-transmitting mirror P includes: after acquiring a signal of the reconstructed image, a cold light emitted from a light source 41 (such as a UHP bulb, a LED light source, a laser mixed light source, or the like) propagates through a convergent lens 42 and a refractive lens 43, and is incident on a synthesis bar 44; the light is then homogenized by the synthesis bar 44, and separated into RGB three colors by a color wheel 45; the light goes through a refractive lens 46, a transmission lens 47 and a TIR (total internal reflection) prism 49, and is incident on a DMD (digital micro-mirror device) chip 48; the DMD chip 48 controls reflection of the light based on the signal of the reconstructed image; after being reflected by the DMD chip 48, the light is projected outward by a projection lens 410. For example, the projection lens 410 projects the light outward on the half-reflecting and half-transmitting mirror P, and so, a clear image restoring true colors can be achieved and is projected on the half-reflecting and half-transmitting mirror P. In addition, the reconstructed image in the embodiment can also be incident onto the half-reflecting and half-transmitting mirror P through another image display apparatus, and is not limited to the above type of projection devices. No specific limitation is placed herein.

In addition, in an exemplary image reconstruction device, as shown in FIG. 5, after a pixel image of a low resolution display screen is captured by a camera (e.g., a CCD), the image is reconstructed by the processing unit, and then the reconstructed image is projected by a projector onto the lens combination including the half-reflecting and half-transmitting mirror. The lens combination reflects the image projected by the projector into human eyes, and at the same time, the initial image goes through the half-reflecting and half-transmitting mirror and is also incident into the human eyes. In this case, what the human eyes can see is a superimposition of the low resolution initial image and the reconstructed image reflected to the human eyes, and so, a high resolution display effect can be achieved with a low resolution display screen.

In another embodiment of the present disclosure, a glasses device is provided, and the glasses device includes the above image reconstruction device. The glasses device according to the embodiment is provided with the above image reconstruction device, and so, an image displayed on a low resolution display screen can be incident into the human eyes with high resolution after passing through the image reconstruction device.

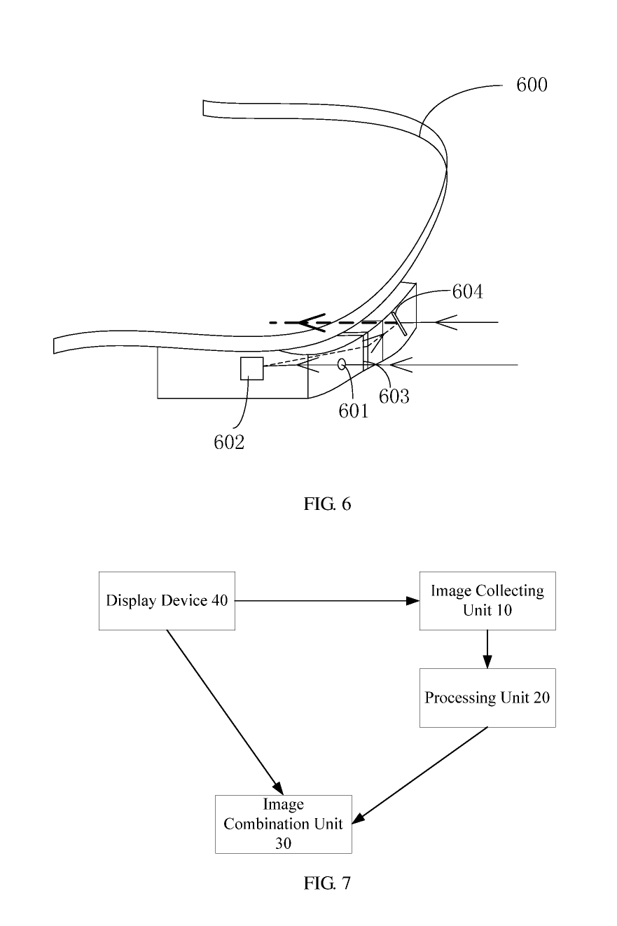

For example, as shown in FIG. 6, in the glasses device of the embodiment, the above image reconstruction device can be mounted on existing glasses. For example, a CCD camera 601, a processor 602, a projector 603 and a half-reflecting and half-transmitting mirror 604 are mounted on a glasses frame 600. A low resolution image collected by the CCD camera 601 is processed by the processor 602 and then projected onto the half-reflecting and half-transmitting mirror 604 by the projector 603. The image signal is incident into the human eyes after being reflected by the half-reflecting and half-transmitting mirror 604. At the same time, by controlling the time when the original low resolution image is incident into the half-reflecting and half-transmitting mirror, the reconstructed image and the initial image can be incident into the human eyes simultaneously, and so, the image incident into the human eyes is the superimposition of the reconstructed image and the initial image. A purpose of improving resolution is therefore achieved.

In another embodiment, as shown in FIG. 7, the image reconstruction device can be mounted on a display device 40 to form a display system. The display device 40 is preset with gaps between adjacent pixel groups. The display device 40 is used for displaying the initial image having pixel gaps between adjacent pixel groups. Moreover, for the initial image, it can be acquired by the image colleting unit 10 and then processed by the processing unit 20, and can be directly displayed on the image combination unit 30 by the display device 40 to perform combination of the images. By this arrangement, the display system can achieve high-resolution image display effect with a low resolution display device.

In the embodiment, the display device is used to display the initial image having pixel gaps between adjacent pixel groups, and the size of each pixel gap is larger than or equal to the size of each pixel group. Meanwhile, each pixel group can be set as one row or one column of pixels, or can be a pixel group formed by a single pixel or formed in other ways. As long as the above image reconstruction process can be achieved, there is no specific limitation placed herein.

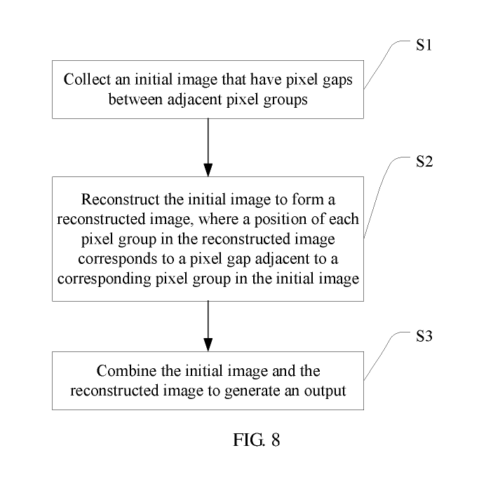

In still another embodiment of the present disclosure, an image reconstruction method is provided. As shown in FIG. 8, the method includes:

Step S1: collecting an initial image that have pixel gaps between adjacent pixel groups;

Step S2: reconstructing the initial image to form a reconstructed image, where a position of each pixel group in the reconstructed image corresponds to a pixel gap adjacent to a corresponding pixel group in the initial image;

Step S3: combining the initial image and the reconstructed image to generate an output.

For example, in the step S3, the pixels in the initial image and the pixels in the reconstructed image are combined by a lens combination. The lens combination includes a half-reflecting and half-transmitting mirror. Combining the initial image and the reconstructed image to generate an output includes: inputting the initial image into the half-reflecting and half-transmitting mirror, where the initial image transmits through the half-reflecting and half-transmitting mirror; projecting the reconstructed image on the half-reflecting and half-transmitting mirror, where the reconstructed image is reflected by the half-reflecting and half-transmitting mirror; and combining the transmitted initial image with the reconstructed image to form a combined image, where pixels in the combined image are combination of the pixels in the initial image and the pixels in the reconstructed image.

The image reconstruction method according to the embodiment can be applied in an image reconstruction process of an image reconstruction device, and can also be applied in an image reconstruction process in a glasses device or in an image reconstruction system. For example, on a basis of an existing low resolution display apparatus, by performing image reconstruction on a low resolution image through the above method, a high resolution display can be achieved with the low resolution image generated by the low resolution display apparatus. In addition, the above image reconstruction method can be achieved by various ways other than the device or system described in the above embodiments of the present disclosure, and all the apparatus should be fallen within the scope of the image reconstruction method according to the present disclosure, as long as they can perform the above image reconstruction process.

In the image reconstruction method and device, the glasses device, and the display system provided by the embodiments of the present disclosure, by offsetting or shifting pixel positions of the low resolution initial image and combining the reconstructed image with the initial image, the resolution of the image to be displayed after combination can be improved. A high resolution display can be achieved, and thus, a high definition display effect can be reached.

In the present disclosure, terms such as “first”, “second” and the like used in the present disclosure do not indicate any sequence, quantity or significance but only for distinguishing different constituent parts. Also, the terms such as “a,” “an,” or “the” etc., are not intended to limit the amount, but indicate the existence of at lease one. The terms “comprises,” “comprising,” “includes,” “including,” etc., are intended to specify that the elements or the objects stated before these terms encompass the elements or the objects and equivalents thereof listed after these terms, but do not preclude the other elements or objects.

The foregoing are merely specific embodiments of the invention, but not limitative to the protection scope of the invention. One skilled in the art could devise variations or replacements that within the scope and the spirit of the present invention, those variations or replacements shall belong to the protection scope of the invention. Thus, the protection scope of the invention shall be defined by the accompanying claims.

The present disclosure claims the benefits of Chinese patent application No. 201510708689.8, which was filed on Oct. 27, 2015 and is incorporated herein in its entirety by reference as part of this application.

What is claimed is:

1. An image reconstruction device, comprising:
an image collecting unit, a processing unit and an image combination unit, wherein:
the image collecting unit is configured to collect an initial image that has pixel gaps between adjacent pixel groups;
the processing unit is configured to reconstruct the initial image to form a reconstructed image, wherein a position of each pixel group in the reconstructed image corresponds to a pixel gap adjacent to a corresponding pixel group in the initial image; and
the image combination unit is configured to combine the initial image and the reconstructed image to generate an output.

2. The image reconstruction device according to claim 1, wherein the image combination unit includes a lens combination, and the lens combination combines pixels in the initial image with pixels in the reconstructed image.

3. The image reconstruction device according to claim 2, wherein:
the lens combination includes a half-reflecting and half-transmitting mirror;
the half-reflecting and half-transmitting mirror allows the initial image to transmit through and reflects the reconstructed image, and combines the transmitted initial image with the reconstructed image to form a combined image; and
pixels in the combined image are combination of the pixels in the initial image and the pixels in the reconstructed image.

4. The image reconstruction device according to claim 1, wherein:
each pixel group in the initial image includes one row of pixels;
a pixel gap is provided between two adjacent pixel groups in the initial image; and
each pixel group in the reconstructed image is located at a position corresponding to a pixel gap adjacent to a corresponding pixel group in the initial image.

5. The image reconstruction device according to claim 1, wherein:
each pixel group in the initial image includes a single pixel;
a pixel gap is provided between two adjacent pixels in the initial image; and
each pixel in the reconstructed image is located at a position corresponding to a pixel gap adjacent to a corresponding pixel in the initial image.

6. The image reconstruction device according to claim 1, wherein each pixel group in the reconstructed image has a size equal to a size of one pixel gap.

7. The image reconstruction device according to claim 1, wherein each pixel group in the initial image has a size equal to a size of one pixel gap.

8. The image reconstruction device according to claim 1, wherein the image collecting unit is a charge coupled device image sensor.

9. A glasses device comprising the image reconstruction device according to claim 1.

10. A display system comprising a display device and the image reconstruction device according to claim 1, wherein the display device is preset with gaps between adjacent pixel groups and is configured for displaying the initial image.

11. An image reconstruction method, comprising:
collecting an initial image that have pixel gaps between adjacent pixel groups;
reconstructing the initial image to form a reconstructed image, wherein a position of each pixel group in the reconstructed image corresponds to a pixel gap adjacent to a corresponding pixel group in the initial image; and
combining the initial image and the reconstructed image to generate an output.

12. The image reconstruction method according to claim 11, wherein pixels in the initial image and pixels in the reconstructed image are combined by a lens combination.

13. The image reconstruction method according to claim 12, wherein:
the lens combination includes a half-reflecting and half-transmitting mirror; and
combining the initial image and the reconstructed image to generate an output includes:
inputting the initial image into the half-reflecting and half-transmitting mirror, wherein the initial image transmits through the half-reflecting and half-transmitting mirror;
projecting the reconstructed image on the half-reflecting and half-transmitting mirror, wherein the reconstructed image is reflected by the half-reflecting and half-transmitting mirror; and
combining the transmitted initial image with the reconstructed image to form a combined image, wherein pixels in the combined image are combination of the pixels in the initial image and the pixels in the reconstructed image.

14. The image reconstructed method according to claim 11, wherein:
each pixel group in the initial image includes one row of pixels;
a pixel gap is provided between two adjacent pixel groups in the initial image; and
each pixel group in the reconstructed image is located at a position corresponding to a pixel gap adjacent to a corresponding pixel group in the initial image.

15. The image reconstruction method according to claim 11, wherein:
each pixel group in the initial image includes a single pixel;
a pixel gap is provided between two adjacent pixels in the initial image; and
each pixel in the reconstructed image is located at a position corresponding to a pixel gap adjacent to a corresponding pixel in the initial image.

16. The image reconstruction method according to claim 11, wherein each pixel group in the reconstructed image has a size equal to that of one pixel gap.

17. The image reconstruction method according to claim 11, wherein each pixel group in the initial image has a size equal to that of one pixel gap.
